(19) United States
(12) Patent Application Publication
(10) Pub. No.: US 2022/0381310 A1
(43) Pub. Date: Dec. 1, 2022

(54) WAVE-SHAPED STEEL PLATE ENERGY DISSIPATION DAMPER, AND PROCESSING METHOD AND MOUNTING METHOD THEREOF

(71) Applicant: Hohai University, Nanjing (CN)

(72) Inventors: Erjun Wu, Nanjing (CN); Hojatallah Azarkhosh, Nanjing (CN); Fachao Liu, Nanjing (CN)

(73) Assignee: Hohai University, Nanjing (CN)

(21) Appl. No.: 17/686,695

(22) Filed: Mar. 4, 2022

(30) Foreign Application Priority Data
May 26, 2021 (CN) 202110576220.9

(51) Int. Cl. F16F 1/02; F16F 13/00

(52) U.S. Cl. CPC F16F 1/025; F16F 13/007; F16F 2234/00; F16F 2230/0005; F16F 2226/048; E04H 9/02

(57) ABSTRACT

The present disclosure discloses a wave-shaped steel plate energy dissipation damper, and a processing method and a mounting method thereof, and belongs to the technical field of energy dissipation and shock absorption of engineering structures. The damper includes a shell, a shock absorption mechanism, and supporting seats. There are two supporting seats which are respectively mounted at a head end and a tail end of the shell. The shock absorption mechanism includes a moving mechanism and at least one wave-shaped steel plate. The wave-shaped steel plate is located in the shell. One end of the wave-shaped steel plate is fixedly connected to the shell. One end of the moving mechanism extends into the shell to fixedly connect the other end of the wave-shaped steel plate. The other end of the moving mechanism is fixedly connected to the bottom of the supporting seat located at the tail end of the shell.

### CROSS REFERENCE TO RELATED APPLICATION

This patent application claims the benefit and priority of Chinese Patent Application No. 202110576220.9, filed on May 26, 2021, the disclosure of which is incorporated by reference herein in its entirety as part of the present application.

### TECHNICAL FIELD

The present disclosure belongs to the technical field of energy dissipation and shock absorption, and more particularly, relates to a wave-shaped steel plate energy dissipation damper, and a processing method and a mounting method thereof.

### BACKGROUND ART

Earthquake disasters occur frequently in China and even all over the world, and previous strong earthquakes have caused serious loss of life and property. For decades, a lot of research work has been done to improve the earthquake resistance of engineering structures at home and abroad.

Traditional methods can resist the actions of strong earthquakes by increasing cross-sectional sizes or using materials with higher strength. However, due to the contingency of the magnitude of an earthquake action, building structures involved in the traditional method does not have the capacity of performing self-regulation on external loads. Even if the designed structures have very strong earthquake resistance, the occurrence of an earthquake beyond the fortification intensity cannot be avoided. Therefore, the safety still cannot be guaranteed.

With the development of a vibration theory and the progress of a technology, a concept of vibration control is put forward, that is, the dynamic characteristics of the structure are changed or adjusted by mounting a certain device and mechanism or certain equipment applying an external force at a specific part of the engineering structure, so as to reasonably control the response of the structure under a dynamic load (such as displacement, velocity, strain or acceleration).

At present, the most common vibration control methods are vibration isolation and damper energy dissipation, which has fundamentally changed a modern earthquake-resistant design. Among them, the research and application of various dampers is one of the hot topics in the field of engineering earthquake resistance. Engineering practice shows that the earthquake resistance of the structure mounted with a damper has been greatly improved.

A damper is a device to provide motion resistance and dissipate and reduce motion energy. The types of the damper can be divided into a velocity dependent type, a displacement dependent type, and other types. Among them, the velocity dependent type is mainly a fluid viscous damper, and a viscous fluid (oil) damper and a viscoelastic damper are common. Displacement dependent type dampers include metal dampers (a mild steel damper, a stiffened steel plate damper, a shear steel plate damper, and a buckling support and lead extrusion damper) and friction dampers. Other types of dampers mainly include a Tuned Mass Damper (TMD), a Tuned Liquid Damper (TLD), and the like.

In a damper family, a friction damper has strong energy dissipation capacity and has small influence of load magnitude and frequency on it, and the structure is simple, materials are easily obtained, and the manufacturing cost is low. It is recognized as a damper type with a good development prospect in the industry.

Since 1970s, scholars at home and abroad have developed a variety of friction dampers, including a common friction damper, a Pall friction damper, a Sumitomo friction damper, a macaroni shear hinge damper, a sliding long hole bolt joint damper, a T-shaped core plate friction damper, a quasi-viscous friction damper, a multi-stage friction damper, and some friction composite energy dissipaters. In addition to the multi-stage friction dampers, the former ones work under strong earthquakes, but can only be used as common supports in small and medium earthquakes, so the use efficiency is low. The structure of the multi-stage friction damper is complex.

By searching, relevant patents have been disclosed to solve the problems of low use efficiency and complex structure of the existing dampers. For example, the invention patent application with the Chinese patent application No. of CN201810997822.X and the application date of Aug. 29, 2018 discloses a wave-shaped energy dissipation steel plate coordinated outer and inner cylinder damper, which includes an upper plate, a lower plate, an upper plate screw hole, a lower plate screw hole, an outer circular energy dissipation steel plate, a locking nut, an inner circular energy dissipation steel plate, a coordinating connecting reinforcement steel bar, an end energy dissipation steel plate, an elastic binding filling material, a foam aluminum energy dissipation material, a semicircular wave-shaped energy dissipation steel plate wave crest section, and a semicircular wave-shaped energy dissipation steel plate wave trough section. According to the present disclosure, energy is dissipated through bending deformation of the outer circular energy dissipation steel plate and the inner circular energy dissipation steel plate and the energy is dissipated through mutual extrusion with the elastic binding filling material and the foam aluminum energy dissipation material when relative displacement occurs between the outer circular energy dissipation steel plate and the inner circular energy dissipation steel plate. Therefore, the solution uses more materials, the structure is complex, and the energy dissipation capacity is relatively low.

### SUMMARY

Aiming at the problems that the structure is complex and the energy dissipation capacity is relatively low of the existing damper structure, the present disclosure provides a wave-shaped steel plate energy dissipation damper, and a processing method and a mounting method thereof. The damper of the present disclosure is obtained by performing further improvement on the existing damper. When an earthquake occurs, the structure of the damper deforms, and a moving mechanism drives a wave-shaped steel plate to produce tension and compression deformation and dissipate energy. In addition, the structure of the damper of the present disclosure is relatively simple, the processing and mounting are relatively simple, and the application range is wide.

In order to solve the above-mentioned technical problems, the present disclosure adopts the following technical solutions.

A wave-shaped steel plate energy dissipation damper includes a shell, a shock absorption mechanism, and supporting seats. A through hole is formed in a tail end of the shell. Two supporting seats are arranged, one is fixedly mounted at a head end of the shell, and the other is movably mounted at the tail end of the shell. The shock absorption mechanism includes a moving mechanism and at least one wave-shaped steel plate. The wave-shaped steel plate is located in the shell. One end of the wave-shaped steel plate is fixedly connected to the shell. One end of the moving mechanism extends into the shell to fixedly connect the other end of the wave-shaped steel plate, and the other end of the moving mechanism is fixedly connected to the bottom of the supporting seat located at the tail end of the shell. When the earthquake occurs, the structure of the damper deforms, and the moving mechanism moves, so as to drive the wave-shaped steel plate to produce tension and compression deformation and dissipate energy.

In a further technical solution, the moving mechanism includes a piston and a piston rod. The piston is mounted in the shell and is fixedly connected to the wave-shaped steel plate. One end of the piston rod is fixedly connected to the bottom of the supporting seat located at the tail end of the shell, and the other end of the piston rod is fixedly connected to an upper end surface of the piston. The piston rod drives the piston to move in the shell through the distance change between the two supporting seats, so as to drive the wave-shaped steel plate to produce tension and compression deformation.

In a further technical solution, a friction layer is arranged on a side surface of the piston, and the friction layer is in contact with the inner surface of the shell. The friction energy dissipation is performed by the movement of the piston in the shell.

In a further technical solution, a friction coefficient of the friction layer is greater than 0.3. On the premise of ensuring the same friction energy dissipation capacity, the selection of a material with a greater friction coefficient can reduce the demand for an interfacial pressure, reduce the steel consumption of the shell, and reduce the diameter of a pressure regulating bolt.

In a further technical solution, the wave-shaped steel plate includes a wave crest section, a wave trough section, and a transition section. The thickness of the wave-shaped steel plate is greater than or equal to 20 mm. Both the wave crest section and the wave trough section are semicircular. The circular arc radii of the wave crest section and the wave trough section are the same and are both less than or equal to 40 mm. When the circular arc radii of the wave crest section and the wave trough section of the wave-shaped steel plate are in the range, the energy dissipation capacity is strong. The length of the transition section is 0 to 100 mm, which can ensure that the transition section is not in contact with an inner wall of the shell in an extruded state.

In a further technical solution, at least two pressure regulating bolts are mounted on the shell. The piston is located between the two pressure regulating bolts. The distance between the two pressure regulating bolts is greater than the moving distance of the piston, which will not hinder the movement of the piston in the shell.

In a further technical solution, there is one and only one wave-shaped steel plate. The length of the wave-shaped steel plate is shorter than that of the shell. One end of the wave-shaped steel plate is fixed to a head end of the shell, and the other end of the wave-shaped steel plate is fixedly connected to a lower end surface of the piston. In the solution, only one wave-shaped steel plate is arranged, so the structure is simple.

In a further technical solution, there are two wave-shaped steel plates arranged. The sum of the lengths of the two wave-shaped steel plates is shorter than that of the shell. The two wave-shaped steel plates are arranged in the length direction of the shell in sequence. The piston is mounted between the two wave-shaped steel plates. One end of one of the wave-shaped steel plates is fixedly connected to the head end of the shell, and the other end is fixedly connected to the piston. One end of the other wave-shaped steel plate is fixedly connected to the tail end of the shell, and the other end is fixedly connected to the piston. A reserved hole matched with the diameter of the piston rod is formed in the wave-shaped steel plate close to the tail end of the shell. In the solution, two wave-shaped steel plates are arranged, which ensures that the tension and compression of the wave-shaped steel plates on both sides of the piston are exactly opposite, so that the symmetry during positive and negative displacement is good.

In a further technical solution, there are four wave-shaped steel plates arranged. The four wave-shaped steel plates are equally divided into two groups, each group includes two wave-shaped steel plates, and the two wave-shaped steel plates on each group are arranged side by side. One end of each of the two wave-shaped steel plates of one group is fixedly connected to the head end of the shell, and the other end is fixedly connected to the piston. One end of each of the two wave-shaped steel plates of the other group is fixedly connected to the tail end of the shell, and the other end is fixedly connected to the piston. The piston rod is located between the two wave-shaped steel plates close to the tail end of the shell. In the solution, four wave-shaped steel plates are arranged, and a reserved hole does not need to be formed in the wave-shaped steel plate, which realizes complete energy dissipation capacity symmetry when positive and negative displacement occurs. The energy dissipation capacity is relatively good.

Double energy dissipation mechanisms of the present disclosure are perfectly integrated, which improves the energy dissipation capacity. A plastic deformation area appears in the wave crest section and the wave trough section of the wave-shaped steel plate when the damper has a very small displacement, which has a good hysteretic energy dissipation capacity under large, medium, and small earthquakes. The piston rubs with the inner wall of the shell during sliding to produce great resistance, so as to further dissipate the energy. The friction energy dissipation capacity and the damper stiffness are conveniently adjusted by regulating the pressure regulating bolts, so as to meet a design requirement. When maintenance is needed, high-precision recalibration can be realized by adjusting the tightness of the bolts, which is simple and convenient.

A processing method for a wave-shaped steel plate energy dissipation damper includes the following processing steps:

step one, processing parts: processing a shell, a piston, a piston rod, four wave-shaped steel plates, two supporting seats, and two pressure regulating bolts; forming anchor bolt holes the two supporting seats; forming a through hole in the tail end of the shell;

step two, installing the piston: arranging a pair of temporary internal supports in the shell, opening the interior of the shell by 1 to 2 mm, putting in the piston, and removing the temporary internal support, at this moment, the friction layer on a side surface of the piston being in contact with the inner wall of the shell;

step three, mounting a piston rod: welding one end of the piston rod with the bottom of one of the supporting seats, and enabling the other end of the piston rod to penetrate into the through hole and extend into the shell to fixedly connect an upper end surface of the piston;

step four, fixing the wave-shaped steel plates: equally dividing the four wave-shaped steel plates into two groups, fixedly connecting one end of one group of wave-shaped steel plates to the tail end of the shell, and fixedly connecting the other end of one group of wave-shaped steel plates to the upper end surface of the piston; fixedly connecting one end of the other group of wave-shaped steel plates to the head end of the shell, and fixedly connecting the other end of the other group of wave-shaped steel plates to the upper end surface of the piston; the piston rod being located between the two wave-shaped steel plates close to the tail end of the shell; and

step five, regulating a pressure: mounting pressure regulating bolts, and the distance between the two pressure regulating bolts being greater than the moving distance of the piston.

A mounting method for a wave-shaped steel plate energy dissipation damper includes the following mounting steps:

step one, measuring an angle: measuring a diagonal angle in a field mounting frame;

step two, processing steel haunches: the shapes of the steel haunches being right-angled triangles, and a plurality of mounting holes being formed in a hypotenuse steel plate and right-angle side steel plates;

step three, mounting the steel haunches: mounting the two steel haunches in a diagonal direction of the mounting frame, the hypotenuse steel plate of each steel haunch being perpendicular to the diagonal of the mounting frame, and fixedly connecting the right-angle side steel plates of the steel haunch to the mounting frame through the mounting holes; and

step four, mounting a damper: mounting the damper between the two steel haunches, fixedly connecting anchor bolt holes on the supporting seats to the hypotenuse steel plates of the steel haunches, and the distance between the hypotenuse steel plates of the two steel haunches being 1 to 3 mm greater than the length of the damper.

Compared with the prior art, the present disclosure has the following beneficial effects.

(1) According to the wave-shaped steel plate energy dissipation damper of the present disclosure, the piston slides under the traction of the piston rod to drive the wave-shaped steel plate to deform, so that one end of the wave-shaped steel plate is always tensed and the other end is always compressed, which can realize perfect tension and compression displacement symmetrical energy dissipation and improve the energy dissipation capacity of the damper.

(2) According to the wave-shaped steel plate energy dissipation damper of the present disclosure, the piston rubs with a metal sleeve during sliding, so as to produce great resistance, dissipate energy, and further improve the energy dissipation capacity of the damper.

(3) According to the wave-shaped steel plate energy dissipation damper of the present disclosure, a plastic deformation area appears in the wave crest section and the wave trough section of the wave-shaped steel plate when the damper has a very small displacement, which has a good hysteretic energy dissipation capacity under large, medium and small earthquake, and further improves the energy dissipation capacity of the damper.

(4) According to the wave-shaped steel plate energy dissipation damper of the present disclosure, on the premise of ensuring the same friction energy dissipation capacity, the selection of a material with friction layer a greater friction coefficient can reduce the demand for an interfacial pressure, reduce the steel consumption of the shell, reduce the diameter of a pressure regulating bolt, and reduce the production cost.

(5) According to the wave-shaped steel plate energy dissipation damper of the present disclosure, the friction energy dissipation capacity and the damper stiffness can be conveniently adjusted by regulating the pressure regulating bolts, so as to meet a design requirement. When maintenance is needed, high-precision recalibration can be realized by adjusting the tightness of the bolts.

(6) According to the wave-shaped steel plate energy dissipation damper of the present disclosure, the structure is simple, common steel plates are selected, materials are easily obtained, the cost is low, the application range is wide, the energy consumption capacity is strong, and the wave-shaped steel plate energy dissipation damper is convenient to mount and convenient to maintain.

(7) According to the wave-shaped steel plate energy dissipation damper of the present disclosure, during mounting, the distance between the hypotenuse steel plates of the two steel haunches is 1 to 3 mm greater than the length of the damper. After the bolts at both ends are fastened, the wave-shaped steel plate is adapted to a mounting error by producing a certain tensile displacement.

(8) The wave-shaped steel plate energy dissipation damper of the present disclosure is mounted on the mounting frame through steel haunches, and the steel haunches can improve the bearing capacity of a frame beam column joint, so that a plastic hinge area of a component avoids a beam end, the overall ductility of the structure is improved, and the risk of continuous collapse is reduced.

### BRIEF DESCRIPTION OF THE DRAWINGS

FIG. 1 is a structural schematic diagram of a damper in Embodiment 2 of the present disclosure;

FIG. 2 is a structural schematic diagram of a damper in Embodiment 3 of the present disclosure;

FIG. 3 is a sectional view in A-A direction in FIG. 2;

FIG. 4 is a side view of installation of a wave-shaped steel plate and a shell of the damper in Embodiment 3 of the present disclosure;

FIG. 5 is a side view of installation of the wave-shaped steel plate and a piston of the damper in Embodiment 3 of the present disclosure;

FIG. 6 is a structural schematic diagram of a damper in Embodiment 4 of the present disclosure;

FIG. 7 is a sectional view in A-A direction in the FIG. 6;

FIG. 8 is a side view of installation of the wave-shaped steel plate and a tail end of the shell of the damper in Embodiment 4 of the present disclosure;

FIG. 9 is a side view of installation of the wave-shaped steel plate and the piston of the damper in Embodiment 4 of the present disclosure;

FIG. 10 is a schematic structural diagram the wave-shaped steel plate of the present disclosure;

FIG. 11 is a schematic structural diagram of a supporting seat of the present disclosure;

FIG. 12 is a schematic structural diagram of a steel haunch of the present disclosure;

FIG. 13 is a schematic structural diagram of the damper of the present disclosure being mounted in a mounting frame;

FIG. 14 is a hysteretic curve graph of the wave-shaped steel plate of the present disclosure with the circular arc radius of 65 mm;

FIG. 15 is a hysteretic curve graph of the wave-shaped steel plate of the present disclosure with the circular arc radius of 50 mm;

FIG. 16 is a hysteretic curve graph of the wave-shaped steel plate of the present disclosure with the circular arc radius of 45 mm;

FIG. 17 is a hysteretic curve graph of the wave-shaped steel plate of the present disclosure with the circular arc radius of 40 mm;

FIG. 18 is a hysteretic curve graph of the wave-shaped steel plate of the present disclosure with the circular arc radius of 30 mm;

FIG. 19 is a hysteretic curve graph of the wave-shaped steel plate of the present disclosure with the circular arc radius of 80 mm;

FIG. 20 is a hysteretic curve graph of the wave-shaped steel plate of the present disclosure with the circular arc radius of 85 mm;

FIG. 21 is a hysteretic curve graph of the wave-shaped steel plate of the present disclosure with the circular arc radius of 90 mm;

FIG. 22 is a hysteretic curve graph of the wave-shaped steel plate of the present disclosure with the circular arc radius of 100 mm;

FIG. 23 is a hysteretic curve graph of the wave-shaped steel plate of the present disclosure with the circular arc radius of 105 mm;

FIG. 24 is a hysteretic curve graph of the wave-shaped steel plate of the present disclosure with the circular arc radius of 20 mm and a transition section with the length of 70 mm;

FIG. 25 is a hysteretic curve graph of the wave-shaped steel plate of the present disclosure with the circular arc radius of 20 mm and without a transition section;

FIG. 26 is a hysteretic curve graph of the wave-shaped steel plate of the present disclosure with the circular arc radius of 30 mm and without a transition section; and

FIG. 27 is a hysteretic curve graph of the wave-shaped steel plate of the present disclosure with the circular arc radius of 30 mm and a transition section with the length of 75 mm.

### REFERENCE SIGNS IN THE DRAWINGS

1, damper; 11, shell; 111, through hole; 12—damping mechanism; 121—moving mechanism; 1211, piston; 1212, piston rod; 122, wave-shaped steel plate; 1221, wave crest section; 1222, wave trough section; 1223, transition section; 13, friction layer; 14, supporting seat; 141, anchor bolt hole; 15, pressure regulating bolt; 16, bolt; 17, split bolt;

2, steel haunch; 21—hypotenuse steel plate; 22—right-angle side steel plate; 23—mounting hole; and

3—mounting frame.

### DETAILED DESCRIPTION OF THE EMBODIMENTS

The present disclosure is further described below with reference to specific embodiments and accompanying drawings.

### Embodiment 1

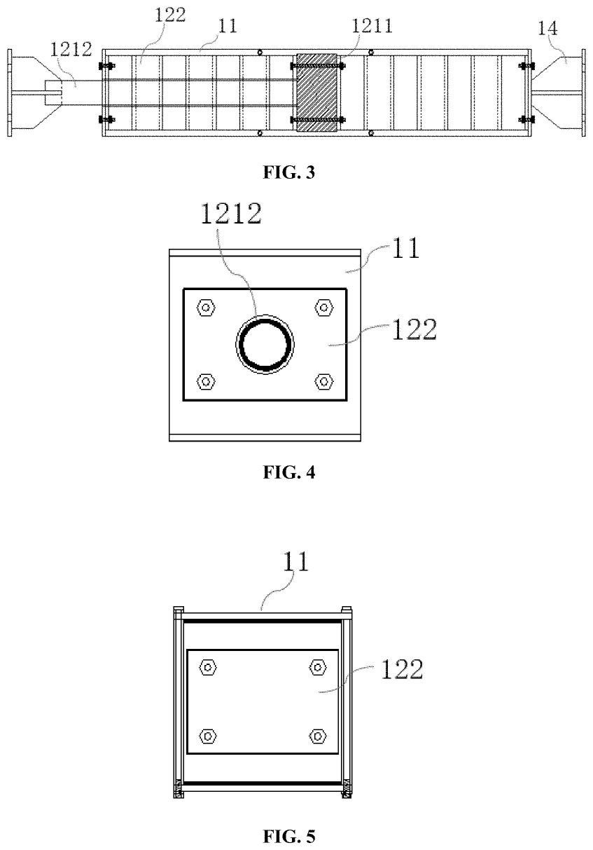

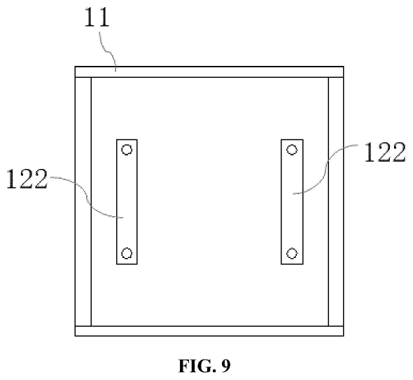

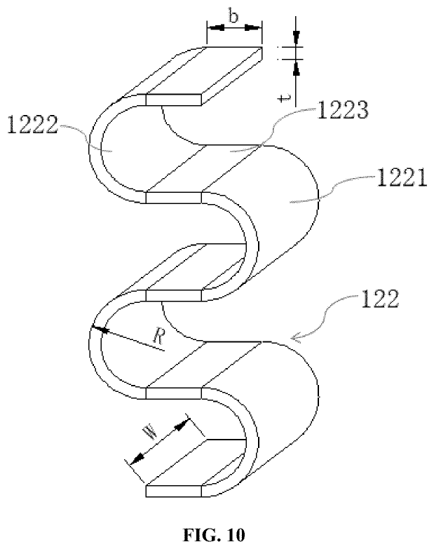

A wave-shaped steel plate energy dissipation damper of the present embodiment, as shown in FIG. 1 to FIG. 9, includes a shell 11, a shock absorption mechanism 12, and supporting seats 14. There are two supporting seats 14 which are respectively mounted at a head end and a tail end of the shell 11. The shock absorption mechanism 12 includes a moving mechanism 121 and at least one wave-shaped steel plate 122. The wave-shaped steel plate 122 is fixedly mounted in the shell 11. One end of the wave-shaped steel plate 122 is fixedly connected to the head end and the tail end of the shell 11. The moving mechanism 121 can tense and compress the wave-shaped steel plate 122, so that tension and compression deformation of the wave-shaped steel plate 122 occurs.

The shell 11 is a rectangular frame body formed by metal plates with certain wall thickness. Four anchor bolt holes 141 are formed in two end surfaces at the head and the tail. The wave-shaped steel plate 122 is fixed by bolts 16.

The moving mechanism 121 includes a piston 1211 and a piston rod 1222. The piston 1211 is mounted in the shell 11. The piston 1211 is made of a metal or ceramic material, so as to ensure enough stiffness and durability. The piston rod 1212 is a hollow steel pipe with a certain wall thickness. The outer diameter of the piston rod 1212 is 40 to 80 mm according to that the outer diameter of the damper 1 is not greater than 200 mm. A through hole 111 is formed in a tail end of the shell 11. The diameter of the through hole 111 is matched with the diameter of the piston 1212. One end of the piston rod 1212 extends into the shell 11 through the through hole 111 and is fixedly connected to the piston 1211 in the shell 11, and the other end of the piston rod 1212 is fixedly connected two a supporting seat 14 located at a tail end of the shell 11. Therefore, when an earthquake occurs, the distance between the two supporting seats 14 will change, so as to drive the piston rod 1212 to further deepen into the shell 11, thereby driving the piston 1211 located in the shell 11 to move.

One end of the wave-shaped steel plate 122 is fixedly connected to the head end or the tail end of the shell 11, and the other end is fixedly connected to the piston 1211. When the piston 1211 moves, the wave-shaped steel plate 122 is driven to produce tension and compression deformation and dissipate energy.

In conclusion, compared with the existing damper 1 which dissipates energy by only relying on a shock absorption material and the deformation of the wave-shaped steel plate 122, the shock absorption mechanism 12 in the present embodiment has relatively good energy dissipation capacity through a principle of driving the wave-shaped steel plate 122 to deform quickly through the piston 1211 and the piston rod 1212 in the moving mechanism 121, so that the deformation of the wave-shaped steel plate 122 enters a plastic area quickly. Moreover, the steel used by the wave-shaped steel plate 122 of the existing damper 1 is high, and the wave-shaped steel plate 122 in the present embodiment may use common steel, which eliminates strict limits on material properties, and reduces the production cost.

### Embodiment 2

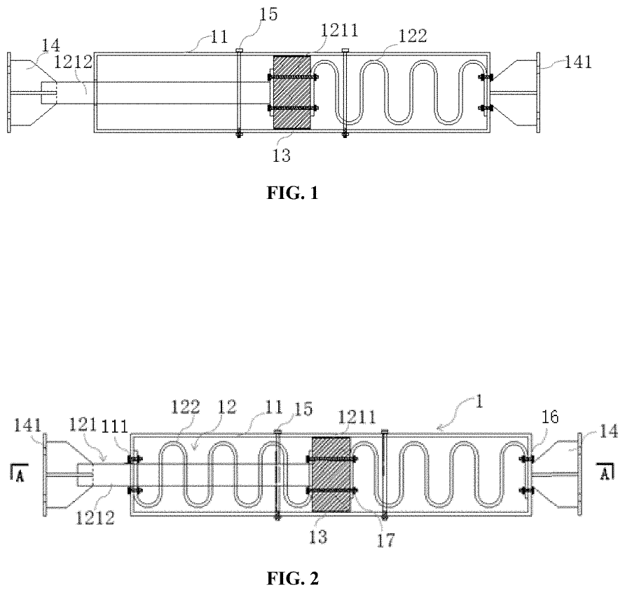

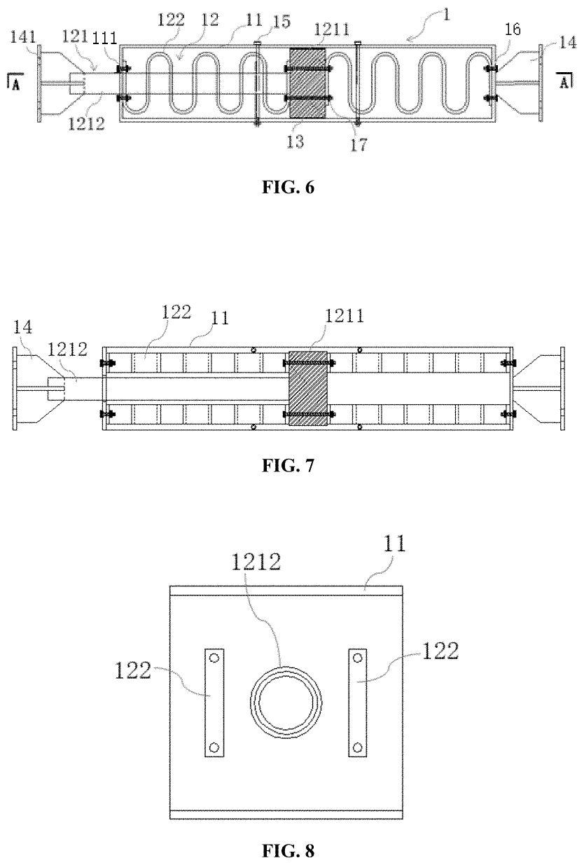

The wave-shaped steel plate energy dissipation damper of the present disclosure, as shown in FIG. 1, FIG. 2, and FIG. 6, a friction layer 13 is arranged on a side surface of the piston 1211, and the friction layer 13 is in contact with an inner surface of the shell 11.

Common friction manners include steel-steel friction, steel-rubber plate friction, aluminum plate-aluminum plate friction, etc. For the common steel-steel friction, a friction coefficient is usually less than 0.15, and the friction energy dissipation capacity is very poor. Therefore, in the present embodiment, no matter which friction manner is selected, the friction coefficient of the friction layer 13 should not be less than 0.3, and even the friction coefficient of the friction layer 13 of aluminum-aluminum friction may exceed 1.0, so that on the premise of ensuring the same friction energy dissipation capacity, the selection of a material with a greater friction coefficient can not only reduce the requirement on the interfacial pressure, reduce the steel consumption of the shell 11, reduce the diameter of pressure regulating bolts 15, reduce the production cost, but also further improve the energy dissipation capacity of the damper 1 through friction energy dissipation.

Further, the pressure regulating bolts 15 are mounted on the shell 11, and the pressure regulating bolts 15 are arranged in pairs, which are not less than two. The piston 1211 is mounted between the two pressure regulating bolts 15. The distance of the two pressure regulating bolts 15 is not greater than 10 times the thickness of the shell 11, so that the distance between the pressure regulating bolts 15 is greater than the moving distance of the piston 1211, which ensures that the pressure regulating bolts 15 cannot hinder the movement of the piston 1211 in the shell 11. These measures may ensures that an upper surface and a lower surface of the shell 11 forms a certain uniform pressure on a surface of the piston 1211, so as to ensure the effect of friction energy dissipation.

In conclusion, the present embodiment further improves the energy dissipation capacity of the damper 1 in a manner of increasing friction energy dissipation, and further improves the effect of friction energy dissipation by giving a certain pressure to the shell 11 and the piston 1211 through the pressure regulating bolts 12, so as to further improve the energy dissipation capacity of the damper 1.

### Embodiment 3

According to the wave-shaped steel plate energy dissipation damper of the present disclosure, a specific structure of a wave-shaped steel plate is as shown in FIG. 10. The wave-shaped steel plate 122 includes a wave crest section 1221, a wave trough section 1222, and a transition section 1223. The thickness of the wave-shaped steel plate is greater than or equal to 20 mm. Both the wave crest section 1221 and the wave trough section 1222 are semicircular, and the circular arc radii of the two are the same and are both less than or equal to 40 mm. The length of the transition section 1223 is 0 to 100 mm, which can ensure that the transition section is not in contact with an inner wall of the shell 11 in an extruded state.

Furthermore, in order to research and analyze the tension-compression energy dissipation performance of different wave-shaped steel plates 122, numerical simulation analysis of energy consumption of different wave-shaped steel plates is performed. The width of the wave-shaped steel plate 122 is W, R is circular arc radius of the wave crest section 1221 and the wave trough section 1222 of the wave-shaped steel plate 122, b is the length of the transition section 1223, and t is the thickness of the wave-shaped steel plate 122.

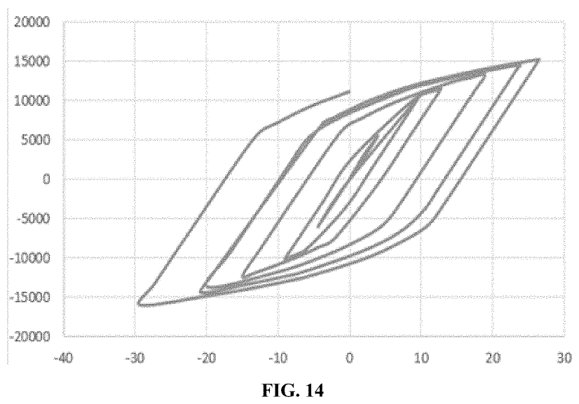

According to the present embodiment, in order to research the energy dissipation performance of the wave-shaped steel plate 122, numerical simulation analysis of the energy dissipation capacity of 14 wave-shaped steel plates under tension-compression low cyclic reversed loading was carried out by changing the value of R under the condition that b and t are fixed, and changing the value of b under the condition that R and t are fixed, which is specifically shown as FIG. 14 to FIG. 27, the abscissa of a hysteretic curve indicates the displacement (mm), and the ordinate indicates the magnitude of force (N).

As shown in FIG. 14, R is 65 mm, b is 150 mm, t is 20 mm, and the hysteretic curve is relatively full.

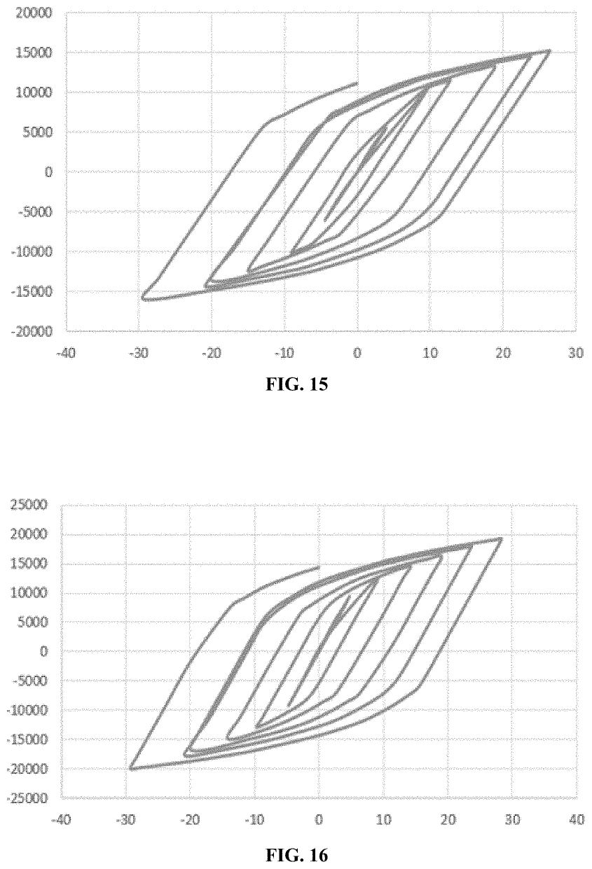

As shown in FIG. 15, R is 50 mm, b is 150 mm, t is 10 mm, and the hysteretic curve is relatively full.

As shown in FIG. 16, R is 45 mm, b is 150 mm, t is 20 mm, and the hysteretic curve is relatively full.

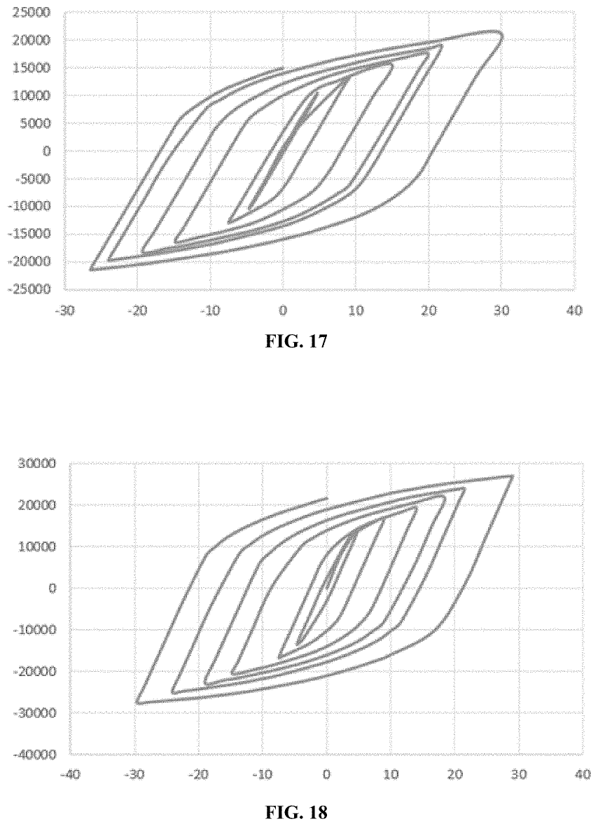

As shown in FIG. 17, R is 40 mm, b is 150 mm, t is 20 mm, and the hysteretic curve is relatively full.

As shown in FIG. 18, R is 30 mm, b is 150 mm, t is 20 mm, and the hysteretic curve is relatively full.

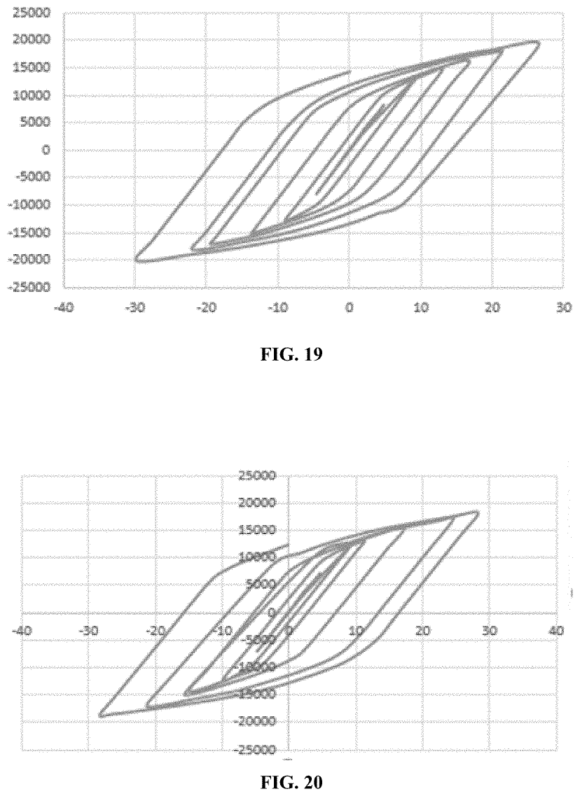

As shown in FIG. 19, R is 80 mm, b is 150 mm, t is 20 mm, and the hysteretic curve is relatively full.

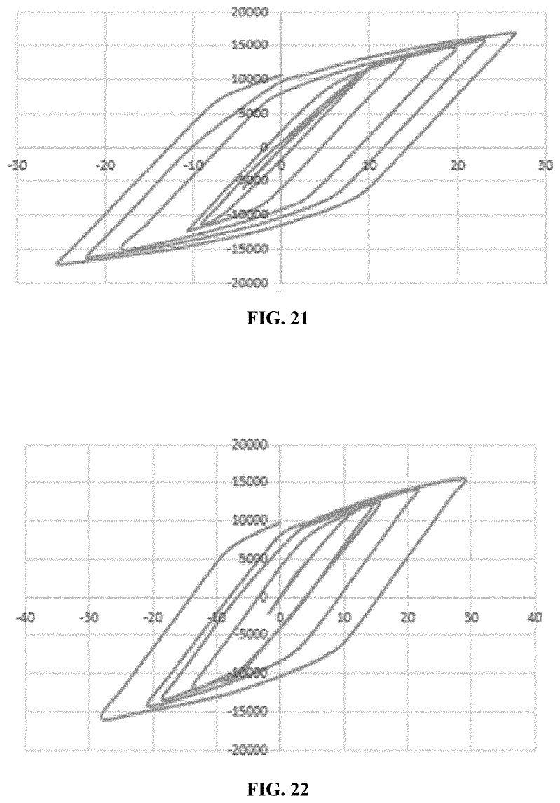

As shown in FIG. 20, R is 85 mm, b is 150 mm, t is 24 mm, and the hysteretic curve is relatively full.

As shown in FIG. 21, R is 90 mm, b is 150 mm, t is 24 mm, and the hysteretic curve is relatively full.

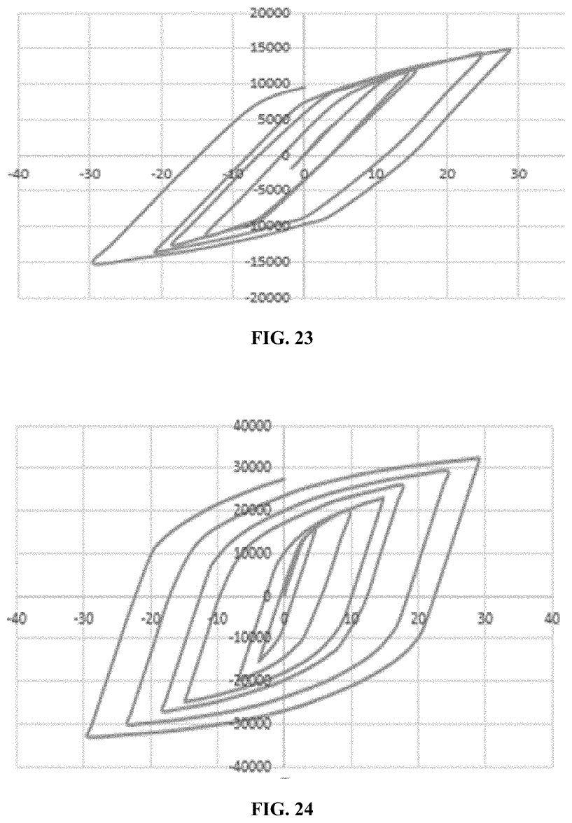

As shown in FIG. 22, R is 100 mm, b is 150 mm, t is 24 mm, and the hysteretic curve is relatively full.

As shown in FIG. 23, R is 105 mm, b is 150 mm, t is 24 mm, and the hysteretic curve is relatively full.

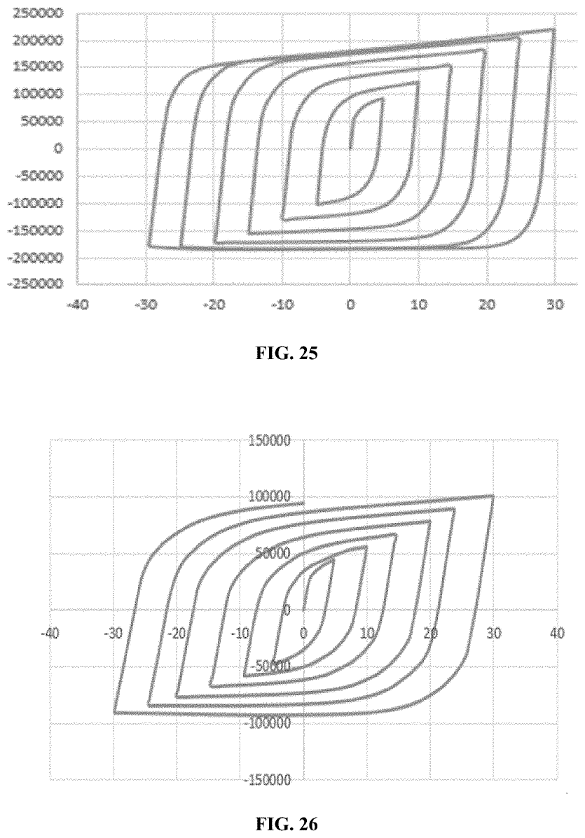

As shown in FIG. 24, R is 20 mm, b is 70 mm, t is 20 mm, and the hysteretic curve is relatively full.

As shown in FIG. 25, R is 20 mm, b is 0 mm, t is 20 mm, and the hysteretic curve is relatively full.

As shown in FIG. 26, R is 30 mm, b is 0 mm, t is 40 mm, and the hysteretic curve is relatively full.

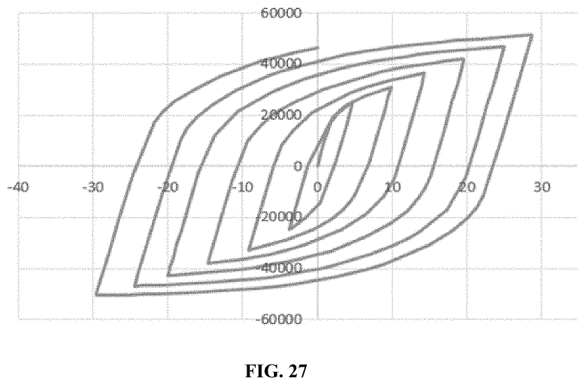

As shown in FIG. 27, R is 30 mm, b is 75 mm, t is 20 mm, and the hysteretic curve is relatively full.

It can be seen from the above-mentioned hysteretic curves that: the hysteretic curves of the energy dissipation changes of the wave-shaped steel plates 122 in the process of repeated tension and compression, which indicates that the wave-shaped steel plates 122 of various model numbers have good energy dissipation capacity and reflect good earthquake resistance. Since both the wave crest section 1221 and the wave trough section 1222 of the wave-shaped steel plate 122 can enter a plastic state quickly, the energy dissipation capacity is good. In addition, the energy dissipation capacity is improved with the increase of the thickness of the wave-shaped steel plate 122, the decrease of the circular arc radii of the wave crest section 1221 and the wave trough section 1222, and the decrease of the length of the transition section 1223.

However, when the circular arc radius R is great, the occupied length space is large, which results in the reduction of the folding times of the wave-shaped steel plate 122 within a unit length range. The energy dissipation of the wave-shaped steel plate 122 is mainly realized by a plastic area generated at the top of a circular arc of the wave crest section 1221 and the wave trough section 1222. The more folding layers, the stronger the energy consumption capacity. Therefore, the circular arc radius R should not be greater than 40 mm. In addition, it is particularly to be noted that with the decrease of the circular arc radius R, the stiffness of the wave-shaped steel plate 122 increases significantly and the total displacement will be affected. Therefore, it is not recommended that the circular arc radius R be too small.

When the length of the transition section 1223 is 150 mm, the energy dissipation capacity is obviously weaker than that when the transition section 1223 is 75 mm and 0 mm (no transition section 1223), so the length of the transition section 1223 should not be greater than 100 mm. Due to the arrangement of the transition section 1223, the tension-compression stiffness of the wave-shaped steel plate 122 can be regulated and controlled conveniently. With the increase of the length b of the transition section 1223, the tension-compression stiffness is reduced significantly. Therefore, the length of the transition section 1223 is greater than 0 mm.

When the length of the transition section 1223 is very small, the decrease of the thickness of the wave-shaped steel plate 122 and the decrease of the circular arc radius will cause the size of the wave-shaped steel plate 122 to be too small. During compression, obvious lateral bending is easily produced. If the length of the transition section 1223 is too large, the tension-compression stiffness is too low. Therefore, the thickness of the wave-shaped steel plate 122 should not be less than 20 mm.

### Embodiment 4

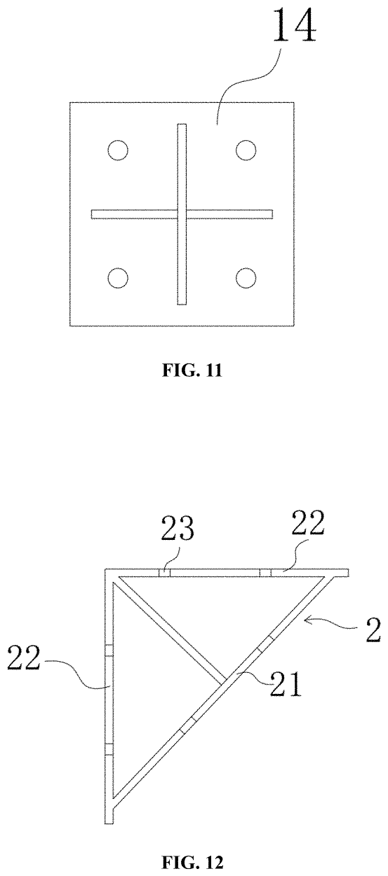

The wave-shaped steel plate energy dissipation damper of the present embodiment is further improved on the basis of Embodiment 5. As shown in FIG. 11, the supporting seats 14 are formed by welding steel plates with certain thickness. Anchor bolt holes 141 are reserved in steel plates at the bottoms of the supporting seats 14. The two steel plates are made into wedge-shaped and cross-shaped, and are welded and fixed to the steel plates at the bottoms. A cross-shaped notch is formed in one end, connected to the supporting seat 14, of the piston rod 1212, which facilitates welding with the cross-shaped wedge-shaped steel plates of the supporting seats 14.

### Embodiment 5

The basic structure of the wave-shaped steel plate energy dissipation damper of the present embodiment is the same as that in Embodiment 4. The difference and improvement are that: as shown in FIG. 1, there is one and only one wave-shaped steel plate 122 in the present embodiment, and its length is shorter than that of the shell 11.

One end of the wave-shaped steel plate 122 is fixedly connected to the head end of the shell 11 by bolts 16, and the other end is fixedly connected to a lower end surface of the piston 1211 through split bolts 17. When an earthquake occurs, the piston rod 1212 drives the piston 1211 to move repeatedly in the shell through the change of the distance between the two supporting seats 14, so as to drive the wave-shaped steel plate 122 to produce tension and compression deformation and dissipate energy.

### Embodiment 6

The wave-shaped steel plate energy dissipation damper of the present embodiment is further improved on the basis of Embodiment 5. As shown in FIG. 2 to FIG. 5, there are two wave-shaped steel plates 122 arranged. The two wave-shaped steel plates 122 are arranged in the length direction of the shell 11 in sequence. The sum of the lengths of the two wave-shaped steel plates 122 is shorter than that of the shell 11.

One end of one of the wave-shaped steel plates 122 is fixedly connected to the tail end of the shell 11 by bolts 16, and the other end is fixedly connected to an upper end surface of the piston 1211 through split bolts 17. One end of the other wave-shaped steel plate 122 is fixedly connected to the head end of the shell 11 by bolts 16, and the other end is fixedly connected to a lower end surface of the piston 1211 by split bolts 17. A reserved hole matched with the diameter of the piston rod 1212 is formed in the wave-shaped steel plate 122 on a side close to the tail of the shell 11, the piston rod 1212 penetrates through a through hole 111 of the shell 11 and the reserved hole of the wave-shaped steel plate 122 to fixedly connect the piston 1211.

When the earthquake occurs, the piston rod 1212 drives the piston 1211 to move repeatedly in the shell 11 through the change of the distance between the two supporting seats 14, so as to drive the wave-shaped steel plate 122 to produce tension and compression deformation and dissipate energy. One end of the wave-shaped steel plate 122 is always tensed and the other end is always compressed, which can realize perfect tension and compression displacement symmetrical energy dissipation. This arrangement manner ensures that the tension and compression of the wave-shaped steel plates 122 on both sides of the piston 1211 are exactly opposite, so that the symmetry during positive and negative displacement is good, and the energy dissipation capacity is further improved.

### Embodiment 7

The wave-shaped steel plate energy dissipation damper of the present embodiment is further improved on the basis of Embodiment 6. As shown in FIG. 6 to FIG. 9, there are four wave-shaped steel plates 122 arranged. The four wave-shaped steel plates 122 are equally divided into two groups. Each group includes two wave-shaped steel plates 122, and the two wave-shaped steel plates 122 in each group are arranged side by side. One end of each of the two wave-shaped steel plates 122 of one group is fixedly connected to the head end of the shell 11 by bolts 16, and the other end is fixedly connected to the lower end surface of the piston 1211 through split bolts 17. One end of each of the wave-shaped steel plates 122 of the other group is fixedly connected to the tail end of the shell 11 by bolts 16, and the other end is fixedly connected to an upper end surface of the piston 1211 through split bolts 17. The piston rod 1212 penetrates through the through hole 111 of the shell 11 and extends into the shell 11 to fixedly connected to the upper end surface of the piston 1211, and the piston rod 1212 is located between the two wave-shaped steel plates 122 close to the tail end of the shell 11.

Further, the two wave-shaped steel plates 122 close to the tail end of the shell 11 are symmetrically mounted in the shell 11 by taking the piston rod 1212 as a symmetric line, and the two wave-shaped steel plates 122 close to the head end of the shell 11 are symmetrically mounted in the shell 11 by taking a straight line where the piston rod 1212 is located as a symmetric line.

In the present embodiment, a reserved hole does not need to be formed in the wave-shaped steel plate 122, so as to ensure the symmetry of energy dissipation. When the wave-shaped steel plate 122 deforms, one end of the wave-shaped steel plate 122 is always tensed, and the other end is always compressed, which realizes the symmetry of the energy dissipation capacity when complete positive and negative displacement occurs, and further improves the energy dissipation capacity.

### Embodiment 8

On the basis of the wave-shaped steel plate in Embodiment 7, the present embodiment provides a processing method for a wave-shaped steel plate energy dissipation damper, as shown in FIG. 12, including the following processing steps.

Step one, parts are processed: a shell 11, a piston 1211, a piston rod 1212, four wave-shaped steel plates 122, two supporting seats 14, and two pressure regulating bolts 15 are processed; a through hole 111 is formed in a tail end of the shell 11; anchor bolt holes 141 are formed in the two supporting seats 14.

Step two, the piston is mounted: a pair of temporary internal supports are arranged in the shell 11, the interior of the shell 11 is opened by 1 to 2 mm, the piston 1211 is put in, and the temporary internal supports are removed. A friction layer 13 is arranged on a side surface of the piston 1211, and the friction layer 13 is in contact with the inner wall of the shell 11. At this time, the piston 1211 can be connected to the shell 11 by only relying on a friction force in the absence of non-gravity external force.

Step three, a piston rod is mounted: one end of the piston rod 1212 is welded with the bottom of one of the supporting seats 14, and the other end penetrates into the through hole 111 and extend into the shell 11 to weld and bolt with an upper end surface of the piston 1211.

Step four, the wave-shaped steel plates are fixed: the four wave-shaped steel plates 122 are equally divided into two groups, one end of one group of wave-shaped steel plates (122) is fixed to the tail end of the shell 11 by bolts 16, and the other end of one group of wave-shaped steel plates is fixed to the upper end surface of the piston 1211 through split bolts 17. One end of the other group of wave-shaped steel plates 122 is fixed to the head end of the shell 11 by bolts 16, and the other end of the other group of wave-shaped steel plates 122 is fixed to the lower end surface of the piston 1211 through split bolts 17. The piston rod 1212 is located between the two wave-shaped steel plates 122 close to the tail end of the shell 11.

Step five, a pressure is regulated: pressure regulating bolts 15 are mounted, and the distance between the two pressure regulating bolts 15 is greater than the moving distance of the piston 1211.

### Embodiment 9

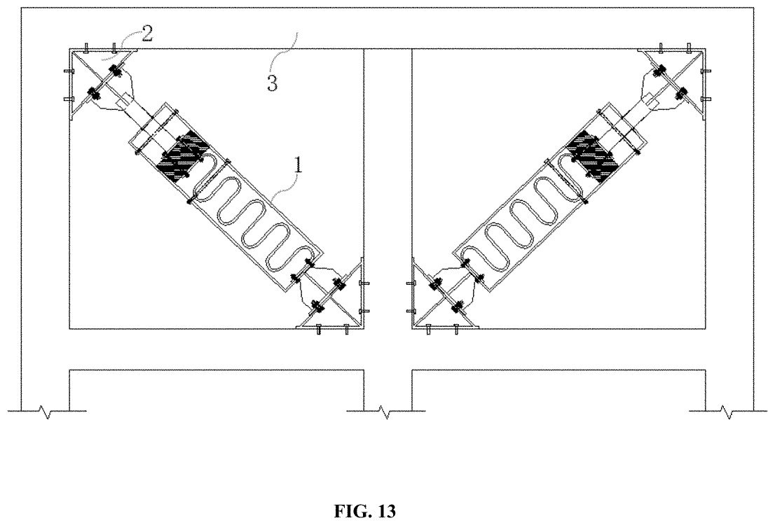

A mounting method for a wave-shaped steel plate energy dissipation damper of the present embodiment, as shown in FIG. 13, includes the following mounting steps.

Step one, an angle is measured: a diagonal angle in a field mounting frame 3 is measured.

Step two, steel haunches are processed: the shapes of the steel haunches 2 are right-angled triangles, and a plurality of mounting holes 23 are formed in a hypotenuse steel plate 21 and right-angle side steel plates 22.

Step three, the steel haunches are mounted. The two steel haunches 2 in a diagonal direction of the mounting frame 3, the hypotenuse steel plate 21 of each steel haunch 2 is perpendicular to the diagonal of the mounting frame 3, and the right-angle side steel plates 22 of the steel haunch 2 are fixedly connected to the mounting frame 3 anchor bolts.

Step four, a damper is mounted: the damper 1 is mounted between the two steel haunches 2, anchor bolt holes 141 in the supporting seats 14 are fixedly connected to the mounting holes 23 in the hypotenuse steel plates 21 of the steel haunches 2 by bolts, and the distance between the hypotenuse steel plates 21 of the two steel haunches 2 is 1 to 3 mm greater than the length of the damper 1.

Each steel haunch 2 consists of two right-angle side steel plates 22, a hypotenuse steel plate 21, a web plate in the same plane with the mounting frame 3, and a pair of stiffening rib plates perpendicular to the hypotenuse steel plate 21 and the web plate. Various plates are welded, and the plane of the stiffening rib plates is consistent with the diagonal of the mounting frame 3.

When an earthquake occurs, the overall structure deforms, so that damper 1 as an energy dissipation support produces tension and compression deformation to push the piston rod 1212 and the piston 1211 to move back and forth. The friction layer 13 on the piston 1211 rubs with an inner wall of the shell 11 to dissipate energy. Meanwhile, when the piston 1211 moves, the wave-shaped steel plate 122 produces tension and compression deformation, and the wave crest section 1221 and the wave trough section 1222 of the wave-shaped steel plate 122 produces plastic deformation to further dissipate the energy. In addition, the steel haunches 2 are arranged, which can improve the bearing capacity of a frame beam column joint of the mounting frame 3, so that a plastic hinge area of a component avoids a beam end, the overall ductility of the structure is improved, and the risk of continuous collapse is reduced.

The embodiments described in the present disclosure are merely description of preferred implementation manners of the present disclosure, and do not limit the concept and the scope of the present disclosure. Various modifications and improvements made to the technical solutions of the present disclosure by those of engineering skill in the art without departing from the design idea of the present disclosure shall fall within the scope of protection of the present disclosure.

1. A wave-shaped steel plate energy dissipation damper, comprising a shell (1) and supporting seats (14), wherein a through hole (111) is formed in a tail end of the shell (11); two supporting seats (14) are arranged, one is fixedly mounted at a head end of the shell (11), and the other is movably mounted at the tail end of the shell (11); the damper (1) further comprises a shock absorption mechanism (12); the shock absorption mechanism (12) comprises a moving mechanism (121) and at least one wave-shaped steel plate (122); the wave-shaped steel plate (122) is located in the shell (11); one end of the wave-shaped steel plate (122) is fixedly connected to the head end or the tail end of the shell (11); one end of the moving mechanism (121) penetrates through the through hole (111) to extend into the shell (11) to fixedly connect the other end of the wave-shaped steel plate (122); and the other end of the moving mechanism (121) is fixedly connected to the bottom of the supporting seat (14) located at the tail end of the shell (11).

2. The wave-shaped steel plate energy dissipation damper according to claim 1, wherein the moving mechanism (121) comprises a piston (1211) and a piston rod (1212); the piston (1211) is mounted in the shell (11) and is fixedly connected to the other end of the wave-shaped steel plate (122); one end of the piston rod (1212) is fixedly connected to the bottom of the supporting seat (14) located at the tail end of the shell (11); and the other end of the piston rod (1212) is fixedly connected to an upper end surface of the piston (1211).

3. The wave-shaped steel plate energy dissipation damper according to claim 2, wherein a friction layer (13) is arranged on a side surface of the piston (1211); and the friction layer (13) is in contact with an inner surface of the shell (11).

4. The wave-shaped steel plate energy dissipation damper according to claim 3, wherein a friction coefficient of the friction layer (13) is greater than 0.3.

5. The wave-shaped steel plate energy dissipation damper according to claim 4, wherein at least two pressure regulating bolts (15) are mounted on the shell (11); the piston (1211) is located between the two pressure regulating bolts (15); and the distance between the two pressure regulating bolts (15) is greater than the moving distance of the piston (1211).

6. The wave-shaped steel plate energy dissipation damper according to claim 2, wherein there is a single wave-shaped steel plate (122); and one end of the wave-shaped steel plate (122) is fixedly connected to the head end of the shell (11), and the other end is fixedly connected to the piston (1211).

7. The wave-shaped steel plate energy dissipation damper according to claim 3, wherein there is a single wave-shaped steel plate (122); and one end of the wave-shaped steel plate (122) is fixedly connected to the head end of the shell (11), and the other end is fixedly connected to the piston (1211).

8. The wave-shaped steel plate energy dissipation damper according to claim 4, wherein there is a single wave-shaped steel plate (122); and one end of the wave-shaped steel plate (122) is fixedly connected to the head end of the shell (11), and the other end is fixedly connected to the piston (1211).

9. The wave-shaped steel plate energy dissipation damper according to claim 5, wherein there is a single wave-shaped steel plate (122); and one end of the wave-shaped steel plate (122) is fixedly connected to the head end of the shell (11), and the other end is fixedly connected to the piston (1211).

10. The wave-shaped steel plate energy dissipation damper according to claim 2, wherein there are two wave-shaped steel plates (122) arranged; one end of one of the wave-shaped steel plates (122) is fixedly connected to the head end of shell (11), and the other end is fixedly connected to a lower end surface of the piston (1211); a reserved hole matched with the diameter of the piston rod (1212) is formed in the other wave-shaped steel plate (122); and one end of the wave-shaped steel plate (122) is fixedly connected to a tail end of the shell (11), and the other end is fixedly connected to an upper end surface of the piston (1211).

11. The wave-shaped steel plate enemy dissipation damper according to claim 3, wherein there are two wave-shaped steel plates (122) arranged; one end of one of the wave-shaped steel plates (122) is fixedly connected to the head end of shell (11), and the other end is fixedly connected to a lower end surface of the piston (1211); a reserved hole matched with the diameter of the piston rod (1212) is formed in the other wave-shaped steel plate (122); and one end of the wave-shaped steel plate (122) is fixedly connected to a tail end of the shell (11), and the other end is fixedly connected to an upper end surface of the piston (1211).

12. The wave-shaped steel plate enemy dissipation damper according to claim 4, wherein there are two wave-shaped steel plates (122) arranged; one end of one of the wave-shaped steel plates (122) is fixedly connected to the head end of shell (11), and the other end is fixedly connected to a lower end surface of the piston (1211); a reserved hole matched with the diameter of the piston rod (1212) is formed in the other wave-shaped steel plate (122); and one end of the wave-shaped steel plate (122) is fixedly connected to a tail end of the shell (11), and the other end is fixedly connected to an upper end surface of the piston (1211).

13. The wave-shaped steel plate enemy dissipation damper according to claim 5, wherein there are two wave-shaped steel plates (122) arranged; one end of one of the wave-shaped steel plates (122) is fixedly connected to the head end of shell (11), and the other end is fixedly connected to a lower end surface of the piston (1211); a reserved hole matched with the diameter of the piston rod (1212) is formed in the other wave-shaped steel plate (122); and one end of the wave-shaped steel plate (122) is fixedly connected to a tail end of the shell (11), and the other end is fixedly connected to an upper end surface of the piston (1211).

14. The wave-shaped steel plate energy dissipation damper according to claim 2, wherein there are four wave-shaped steel plates (122) arranged; the four wave-shaped steel plates (122) are equally divided into two groups; one end of each of the two wave-shaped steel plates (122) of one group is fixedly connected to the head end of the shell (11), and the other end is fixedly connected to the piston (1211); and one end of each of the two wave-shaped steel plates (122) of the other group is fixedly connected to the tail end of the shell (11), and the other end is fixedly connected to the piston (1211).

15. The wave-shaped steel plate energy dissipation damper according to claim 3, wherein there are four wave-shaped steel plates (122) arranged; the four wave-shaped steel plates (122) are equally divided into two groups; one end of each of the two wave-shaped steel plates (122) of one group is fixedly connected to the head end of the shell (11), and the other end is fixedly connected to the piston (1211); and one end of each of the two wave-shaped steel plates (122) of the other group is fixedly connected to the tail end of the shell (11), and the other end is fixedly connected to the piston (1211).

16. The wave-shaped steel plate energy dissipation damper according to claim 4, wherein there are four wave-shaped steel plates (122) arranged; the four wave-shaped steel plates (122) are equally divided into two groups; one end of each of the two wave-shaped steel plates (122) of one group is fixedly connected to the head end of the shell (11), and the other end is fixedly connected to the piston (1211); and one end of each of the two wave-shaped steel plates (122) of the other group is fixedly connected to the tail end of the shell (11), and the other end is fixedly connected to the piston (1211).

17. The wave-shaped steel plate energy dissipation damper according to claim 5, wherein there are four wave-shaped steel plates (122) arranged; the four wave-shaped steel plates (122) are equally divided into two groups; one end of each of the two wave-shaped steel plates (122) of one group is fixedly connected to the head end of the shell (11), and the other end is fixedly connected to the piston (1211); and one end of each of the two wave-shaped steel plates (122) of the other group is fixedly connected to the tail end of the shell (11), and the other end is fixedly connected to the piston (1211).

18. A processing method for a wave-shaped steel plate energy dissipation damper, using the wave-shaped steel plate energy dissipation damper according to claim 14, and comprising the following processing steps:
step one, processing parts: processing a shell (11), a piston (1211), a piston rod (1212), four wave-shaped steel plates (122), two supporting seats (14), and two pressure regulating bolts (15); forming anchor bolt holes (141) in the two supporting seats (14); forming a through hole (111) in the tail of the shell (11);
step two, installing the piston: arranging a pair of temporary internal supports in the shell (11), opening the interior of the shell (11) by 1 to 2 mm, putting in the piston (1211), and removing the temporary internal support, at this moment, the friction layer (13) on a side surface of the piston (1211) being in contact with the inner wall of the shell (11),
step three, mounting a piston rod: welding one end of the piston rod (1212) with the bottom of one of the supporting seats (14), and enabling the other end of the piston rod (1212) to penetrate into the through hole (111) and extend into the shell (11) to fixedly connect an upper end surface of the piston (1211);
step four, fixing the wave-shaped steel plates: equally dividing the four wave-shaped steel plates (122) into two groups, fixedly connecting one end of one group of wave-shaped steel plates (122) to the tail end of the shell (11), and fixedly connecting the other end of one group of wave-shaped steel plates to the upper end surface of the piston (1211); fixedly connecting one end of the other group of wave-shaped steel plates (122) to the head end of the shell (11), and fixedly connecting the other end of the other group of wave-shaped steel plates (122) to the upper end surface of the piston (1211); and
step five, fastening: mounting pressure regulating bolts (15).

19. A mounting method for a wave-shaped steel plate energy dissipation damper, using the wave-shaped steel plate energy dissipation damper according to claim 1, and comprising the following mounting steps:
step one, measuring an angle: measuring a diagonal angle in a field mounting frame (3);
step two, processing steel haunches: the shapes of the steel haunches (2) are right-angled triangles, and a plurality of mounting holes (23) are formed in a hypotenuse steel plate (21) and right-angle side steel plates (22);
step three, mounting the steel haunches: mounting the two steel haunches (2) in a diagonal direction of the mounting frame (3), the hypotenuse steel plate (21) of each steel haunch (2) being perpendicular to the diagonal of the mounting frame (3), and fixedly connecting the right-angle side steel plates (22) of the steel haunch (2) to the mounting frame (3) through the mounting holes (23); and
step four, mounting a damper: mounting the damper (1) between the two steel haunches (2), fixedly connecting supporting seats (14) to the hypotenuse steel plates (21) of the steel haunches (2), and the distance between the hypotenuse steel plates (21) of the two steel haunches (2) being 1 to 3 mm greater than the length of the damper (1).
